(19) United States
(12) Patent Application Publication
(10) Pub. No.: US 2011/0062187 A1
(43) Pub. Date: Mar. 17, 2011

(54) BULK PRODUCT DISPENSER HAVING A DISPENSING ACTUATOR LOCKING ASSEMBLY

(75) Inventors: SCOTT JOHNSON, LITTLE ROCK, AR (US); RONALD BRUNDICK, ROLAND, AR (US)

(73) Assignee: TRADE FIXTURES, LLC., LITTLE ROCK, AR (US)

(21) Appl. No.: 12/879,381

(22) Filed: Sep. 10, 2010

Related U.S. Application Data
(60) Provisional application No. 61/241,430, filed on Sep. 11, 2009.

(51) Int. Cl. B67B 1/00; B67D 7/06

(52) U.S. Cl. 222/153.14; 222/185.1

(57) ABSTRACT

A dispensing actuator locking assembly for a bulk inventory dispenser. The dispenser includes a housing, a lockable dispensing actuator pivotally connected to the housing, and a gate connected to the dispensing actuator and adapted to pivot between a closed position and an open position to selectively dispense the bulk product through an opening in the housing when the dispensing actuator is in an unlocked condition. The dispensing actuator cannot be accidentally actuated unless and until the locking assembly is purposefully disengaged by the user of the dispenser.

This application claims priority to U.S. Provisional Patent Application No. 61/241,430, filed Sep. 11, 2009, the entire contents of which are hereby incorporated by reference thereto.

### RELATED PATENTS

U.S. Pat. Nos. 6,182,864 and 6,241,123 to Elmore, both of which are owned by Trade Fixtures, LLC of Little Rock, Ark. and which teach gravity-fed dispensing systems. The teachings of both patents are incorporated herein by reference thereto.

### FIELD

The present invention relates generally to a bulk inventory dispensing apparatus and, more particularly, to a gravity-fed dispensing apparatus with a locking dispensing actuator. The apparatus allows bulk inventory stored in a dispensing bin to flow under the force of gravity upon release of a dispensing actuator locking portion of the bin thereby enabling rotation of the dispensing actuator. Once released, the dispensing actuator can then be articulated to permit stored inventory to be dispensed through an output portal of the bin into a receptacle.

### BACKGROUND

Gravity-fed bins for dispensing bulk inventory are used to dispense a wide variety of materials having a range of sizes and aggregate make-ups as diverse as hardware components, e.g., nuts and bolts, to retail grocery food, e.g., pastas, cereals, nuts, coffee (either beans or ground), dried soup mixes, candies, spices, and the like. Generally, such a bin is comprised of a hopper-type enclosure having an inlet at an upper end utilized to fill the enclosure with bulk inventory, an outlet or chute at its lower end utilized to dispense the material, and a flow control device located intermediate the upper and lower openings and controlled by a manually-actuated gate mechanism. This arrangement, in turn permits manipulation of the amount of inventory being dispensed during the interval the handle or other control device is actuated. In operation, as the inventory is being dispensed, the force of gravity causes the portion stored above in the cavity to progressively migrate towards the lower end to replace the void left as portions of the inventory is dispensed. These types of bins generally include a downwardly angled or curving floor within the cavity that forms a slide to channel the stored inventory into a receptacle downstream from the outlet gate. Examples of prior art gravity fed bins can be found in the above-mentioned U.S. patents to Elmore, U.S. Pat. No. 4,903,866 to Loew, NewLeaf Designs' Vita-Bin® gravity bin product, and BestBins Corporation's gravity bins product.

Heretofore, the one means for dispensing such stored bulk inventory was to employ a bulk food dispenser generally known as a “scoop bin.” As the name suggests, a scoop bin typically comprises a plastic bin, often having a hinged lid that is lifted to provide the consumer access to the stored contents. A hand scoop is then employed to gather the bulk product for placement into a container. While scoop bins are effective for dispensing a wider variety of product than a gravity type dispenser, they suffer from several major disadvantages, particularly in the area of hygiene, because of the contamination that can take place in these types of dispensers. Sources of contamination include germs that may be attached to the scoop or scoop handle being transferred to the stored product during dispensing or from external debris falling into the bin cavity when the bin's lid is lifted. Lastly, since the nature of scoop bins requires their openings to be located closer to the floor for access reasons, they are generally within the reach of children and others who are not hesitant to reach into the unsecured bins with potentially unclean hands in order to extract a sample, or even play with the bin contents. In addition, scoop bins also suffer from inventory shrinkage, both from pilferage and from accidental spillage.

Gravity-fed bins offer a multitude of advantages compared to other dispensing means, such as scoop bins, including convenience, ease of use and hygiene. However, the ease in which inventory can be dispensed from gravity-fed dispensers sometimes works against itself in that the handle may be easily actuated and thus dispense inventory through the chute regardless of whether there is a receptacle in place to catch it. This type of dispensing may be accidental, such as a child in a grocery cart tugging on a bin handle, or less so in the case of pilferage or pranks emanating from a portion of grocery clientele and is often referred to as “shrink” or “shrinkage.”

Bulk inventory shrinkage adversely affects a grocery retailer in a number of ways. First there is the cost of replacing the lost inventory that was dispensed from the gravity-fed bin without payment. Second, shrinkage stemming from accidental spills can make a mess that must be quickly cleaned up. There remains a need for a reliable, clean and easy to operate bulk inventory dispenser that can save costs by reducing shrinkage.

### SUMMARY

The invention disclosed herein addresses and overcomes the shortcomings inherent in providing the consuming public access to self-serve, gravity-fed bulk inventory bins. The present invention provides a means for locking out a dispensing actuator until a user of the bin physically pulls down on a grip surrounding an output portal. Since the consumer would normally surround the output portal with the opening of a plastic bag or the like, dispensed materials will be directed to where they are intended, that is, a bag containing bulk inventory to be taken to the checkout and paid for.

The bulk product dispenser with a bag grip release according to the present invention is preferably constructed of molded clear plastic, such as polycarbonate, but other materials and color configurations are anticipated. For food related dispensers, it is also preferable to utilize materials that have been approved by the U.S. Food and Drug Administration and constructed in accordance with food service specifications issued by NSF Int'l of Ann Arbor, Mich.

One aspect of the present invention is a locking means for a dispenser of stored bulk inventory. The dispenser comprises a housing, a lower opening in the housing comprising an output portal, a dispensing actuator pivotally connected to the housing, a gate connected to the dispensing actuator and adapted to pivot between a closed position and an open position between a storage cavity and a dispensing cavity within the dispenser, a locking mechanism in communication with the dispensing actuator to prevent its unintentional actuation, and an actuator proximate the output portal and coupled to the locking mechanism. When a consumer properly places a receiving container at a predetermined position relative to the output portal, it triggers an actuator thereby releasing the locking mechanism and thus allows rotation of the dispensing actuator and the dispensing of the bulk inventory from the dispenser through an opening in the housing and ultimately into the receiving container.

### BRIEF DESCRIPTION OF THE DRAWINGS

Further features of the inventive embodiments will become apparent to those skilled in the art to which the embodiments relate from reading the specification and claims with reference to the accompanying drawings, in which:

FIG. 1 is a side elevation of a gravity-fed, bulk inventory dispenser in the art according to U.S. Pat. No. 6,241,123;

FIG. 2 is a front end elevational view of a bulk product dispenser in a locked condition according to an embodiment of the present invention;

FIG. 3 is a side elevational view of the bulk product dispenser of FIG. 2;

FIG. 4 is a front end elevational view of the bulk product dispenser of FIG. 2 in an unlocked condition according to an embodiment of the present invention;

FIG. 5 is a side elevational view of the bulk product dispenser of FIG. 4; and

FIGS. 6A through 6D show the bulk product dispenser of FIG. 1 being utilized to dispense product.

### DETAILED DESCRIPTION

In the discussion that follows, like reference numeral are used to refer to like elements in the various figures.

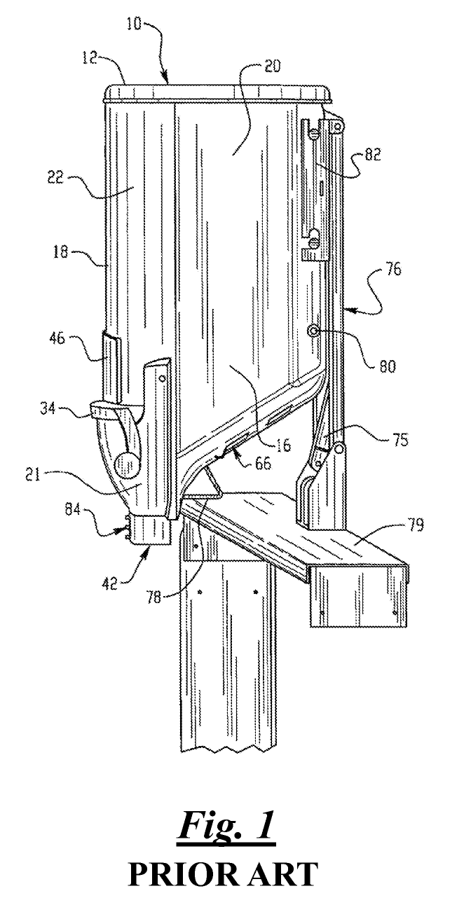

A gravity-fed, bulk inventory dispenser 10 as available in the art from Trade Fixtures, LLC of Little Rock, Ark. is shown in FIG. 1. Dispenser 10 includes a housing 18 for storing bulk product. Housing 18 is shown mounted to a base 79 via mounting arm 76. As can be seen, a dispensing area 21 is contiguous to an output portal 42 which is shown fitted with stationary bag grip ribs at 84. Housing 18 may also include a detachable front portion 22 to provide access to a portion of the interior of dispenser 10 for service and maintenance.

A lid 12 fits atop housing 18 to provide selectable access to the interior of the housing for refilling depleted bulk inventory. Lid 12 may be removable or hinged to housing 18, and may be held in place in any conventional manner, such as mating projections on the lid and/or the housing.

A dispensing actuator 34 is pivotally attached to housing 18. A gate (not shown) is arranged to selectively block and unblock an opening (not shown, but internal to the housing 18 proximate dispensing arm 21) between the cavity 16 of housing 18 and dispensing output portal 42. The gate is mechanically coupled to dispensing actuator 34 such that the gate, if unimpeded, raises when the dispensing actuator is pivoted in a predetermined manner. Under this condition, bulk inventory stored within a cavity 16 of bulk inventory dispenser 10 is permitted to flow from within the cavity, through output portal 42 and, preferably, into a consumer-guided receptacle (not shown). While the opening is blocked by the gate, bulk inventory stored in bulk inventory dispenser 10 is prevented from being discharged.

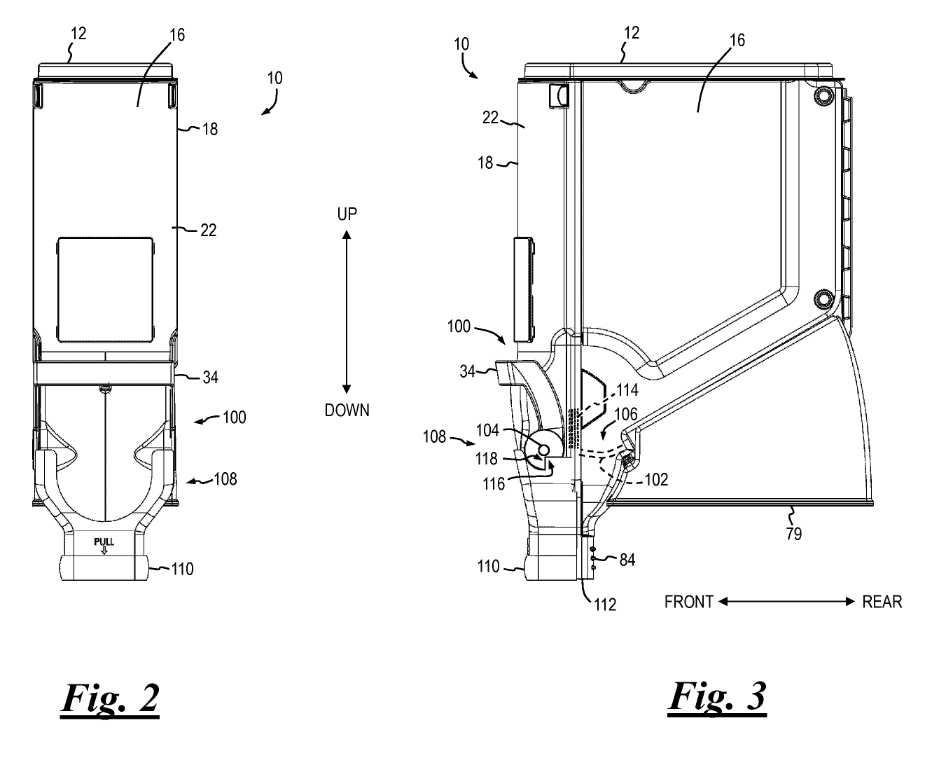

Referring now to FIGS. 2 through 5, details of an embodiment of a dispensing portion 100 of the present disclosure is shown according to an embodiment of the present invention. Dispensing actuator 34 and a gate 102 coupled to the dispensing actuator are held in a predetermined, closed position by a first biasing element 104 such that the gate blocks the flow of stored inventory through an opening passage 106 when the dispensing actuator is not being actuated. Biasing element 104 may be any suitable structure effective to hold dispensing actuator 34 in the predetermined position including, without limitation, elastic materials, helical springs, torsion springs and leaf springs.

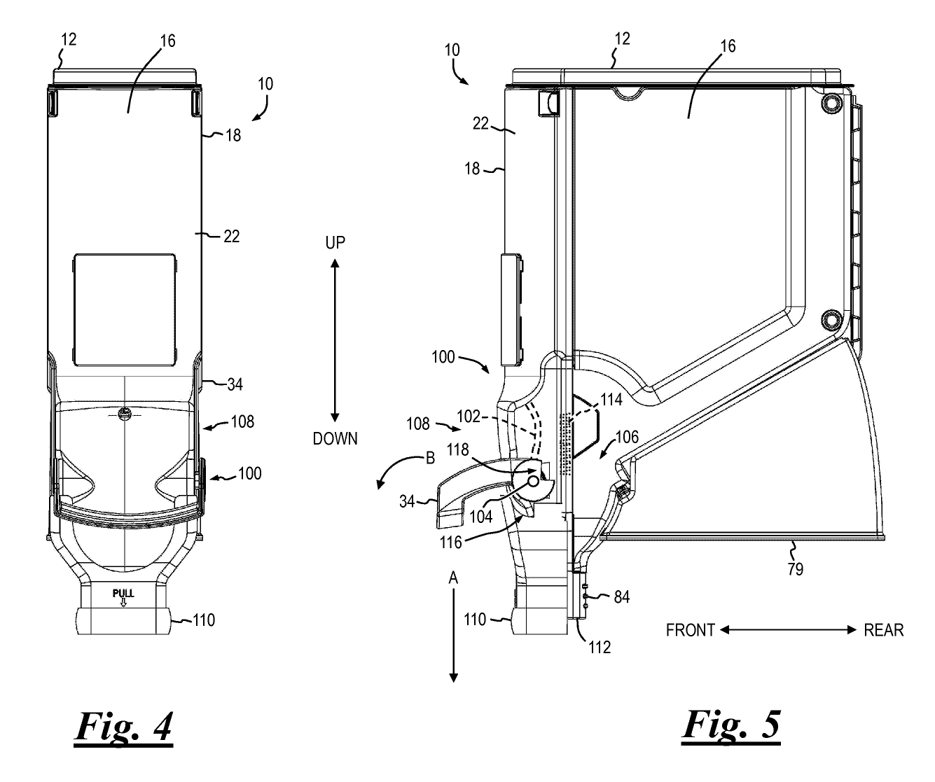

With further reference to FIGS. 2 through 5, a dispensing actuator release assembly 108 is depicted in a locked upward position in FIGS. 2 and 3, and in an unlocked downward position in FIGS. 4 and 5. According to the disclosed embodiment, the dispensing actuator release assembly 108 comprises a bag grip actuator 110 generally surrounding an output portal 112. The bag grip actuator 110 is biased in an upward position by a second biasing element 114 such as, without limitation, elastic materials, helical springs, torsion springs and leaf springs. An upper portion of bag grip actuator 110 includes a first cutout portion 116 that is sized and shaped to receive a similarly sized and shaped second cutout portion 118 of dispensing actuator 34. When at rest, as shown in FIGS. 2 and 3, second cutout portion 118 engages first cutout portion 116, thereby impeding rotation of dispensing actuator 34 and thus deterring movement of gate 102 away from passage 106. If a user pulls on dispensing actuator 34 while the bag grip actuator 110 is in the locked, upward position, dispensing actuator 34 will not rotate and the gate 30 that retains the bulk inventory in the housing 18 is not moved. Conversely, as shown in FIGS. 4 and 5, if bag grip actuator 110 is urged downwardly as at “A,” first and second cutout portions 116 and 118 respectively are disengaged from each other, allowing dispensing actuator 34 to rotate downwardly as at “B” and gate 102 to move away from passage 106.

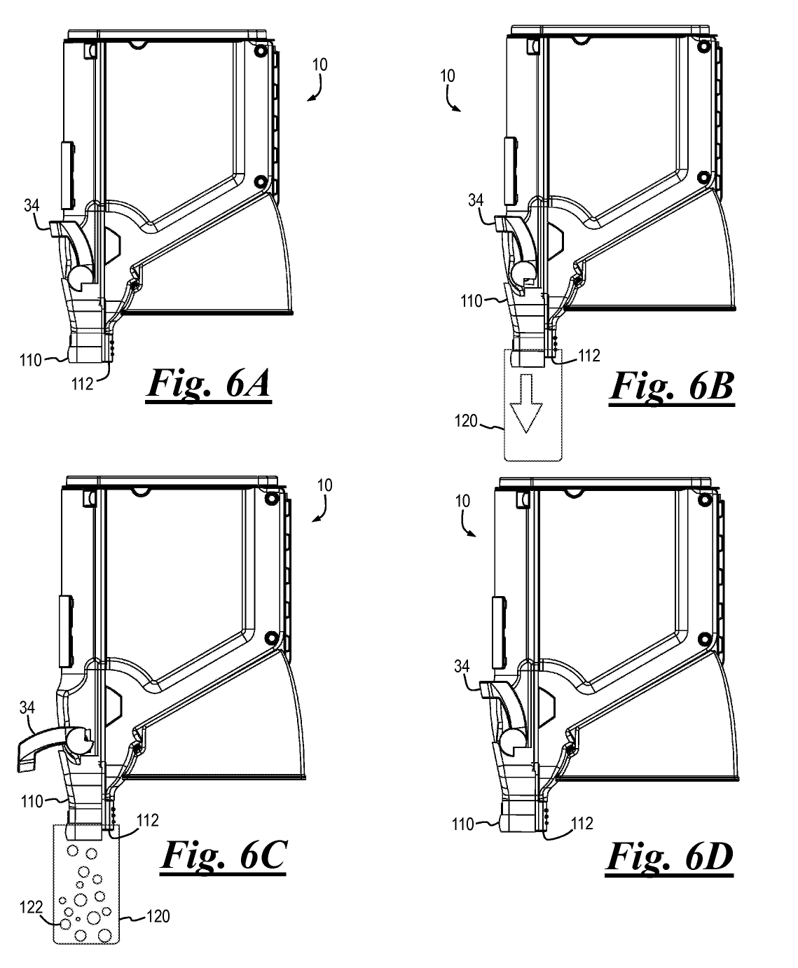

FIGS. 6A through 6D illustrate the dispenser 10 of the present invention in operation. Firstly, FIG. 6A shows dispenser 10 with dispensing actuator release assembly 108 in its locked position, deterring movement of dispensing actuator 34 and gate 106. In FIG. 6B, a user first places a receptacle 120 around bag grip actuator 110 and below output portal 112. During this step, with the bag grip actuator 110 in the upward position, the dispensing actuator 34 remains locked and will not rotate. As shown in FIG. 6C, bag grip actuator 110 has been urged downwardly, preferably while the user holds receptacle 120 in place around output portal 112. Once bag grip actuator 110 is urged downwardly, dispensing actuator 34 is now unlocked and free to rotate. At this unlocked stage when dispensing actuator 34 is pulled by the user, it rotates and progressively moves gate 102 away from passage 106 (FIG. 5), allowing bulk inventory 122 to flow through the passage for dispensing. Dispensing actuator 34 may be repeatedly actuated by the user until a desired amount of bulk inventory 122 is dispensed into the receptacle 120. Once the desired amount of bulk inventory 122 has been dispensed, the user releases both dispensing actuator 34 and bag grip actuator 110 to their respective positions at rest as at FIG. 6D, thereby causing dispensing actuator 34 to once again be locked from rotating by the re-engagement of the first and second cutout portions.

In addition to using first and second cutout portion 116, 118 respectively with aspects of dispensing actuator 34 in order to prevent its rotation, other dispensing actuator locking arrangements are anticipated by the inventors within the scope of the invention. For a non-limiting example, an actuator may be located on a portion of the dispensing actuator 34 itself and provide interference with the rotation of the dispensing actuator until actuated. Likewise, an actuable safety could be employed at a position between the dispensing actuator 34 and the body of the dispensing bin. Only by moving the safety into an unlocked condition could dispensing actuator 34 be rotated and bulk inventory dispensed.

While this invention has been shown and described with respect to a detailed embodiment thereof, it will be understood by those skilled in the art that changes in form and detail thereof may be made without departing from the scope of the claims of the invention.

What is claimed is:

1. A dispenser for stored bulk inventory, comprising:
a generally hollow housing having a cavity;
a lower opening in the housing, the opening forming an output portal;
a dispensing actuator pivotally connected to the housing and pivotable between a generally vertical orientation and a generally horizontal orientation;
a gate coupled to the dispensing actuator and adapted to pivot between a closed position and an open position within the dispenser;
a first biasing element biasing the dispensing actuator to a non-dispensing orientation and further biasing the gate to its closed position;
a bag grip actuator slidably coupled to the output portal and selectably engaging the dispensing actuator; and
a second biasing element biasing the bag grip actuator into engagement with the dispensing actuator,
the dispensing actuator being in a locked condition when the bag grip actuator is engaged thereto, the dispensing actuator further being in an unlocked condition when the bag grip actuator is urged away from the dispensing actuator.

2. The dispenser of claim 1, further comprising:
a first cutout portion formed in the bag grip actuator; and
a second cutout portion formed in the dispensing actuator,
the first and second cutout portions being sized and shaped for engagement together.

3. The dispenser of claim 1 wherein the first biasing element is one of an elastic material, a helical spring, a torsion spring and a leaf spring.

4. The dispenser of claim 1 wherein the second biasing element is one of an elastic material, a helical spring, a torsion spring and a leaf spring.

5. The dispenser of claim 1, further comprising:
a second opening in the housing, the second opening being in communication with the cavity of the housing; and
a lid selectably closing off the second opening.

6. The dispenser of claim 1, wherein the housing includes a detachable front portion.

7. The dispenser of claim 1 wherein the bag grip actuator further includes at least one bag grip rib.

8. The dispenser of claim 1, further including a base to which the housing is attached.
